(19) United States
(12) Patent Application Publication
(10) Pub. No.: US 2026/0093513 A1
(43) Pub. Date: Apr. 2, 2026

(54) DATA PROCESSING

(71) Applicant: Arm Limited, Cambridge (GB)

(72) Inventors: Daren Croxford, Swaffham Prior (GB); Jussi Tuomas Pennala, Lund (SE); Philip Malcolm Done, Cambridge (GB); Mark Stephen Bellamy, Haverhill (GB); Akshay Vijayashekar, Trondheim (NO)

(73) Assignee: Arm Limited, Cambridge (GB)

(21) Appl. No.: 18/899,357

(22) Filed: Sep. 27, 2024

(51) Int. Cl. G06F 9/455; G06F 9/48

(52) U.S. Cl. CPC G06F 9/45558; G06F 9/4881; G06F 2009/45591

(57) ABSTRACT

Disclosed is a graphics processor comprising a plurality of processing elements that are configurable as different, respective “partitions” of the processing elements, each partition of processing elements including one or more processing cores and a scheduling unit. Fault detection and management can then be performed for particular, respective partitions of the processing elements within the graphics processor.

### BACKGROUND

The technology described herein relates to data processing systems including graphics processors (graphics processing units, “GPUs”), and in particular to data processing systems in which multiple, independent graphics processing operations may need to be performed contemporaneously.

It is becoming increasingly common for data processing systems to require processing, e.g., graphics processing operations, for multiple isolated sub-systems. For example, vehicles may have a display screen for the main instrument console, an additional navigation and/or entertainment screen, and an advanced driver assistance system (ADAS). Each of these systems may require their own processing operations to be performed, and it may be necessary, e.g. for formal safety requirements, for them to be able to operate independently of each other.

One approach to such systems would be to provide a single graphics processor that is time shared between the different graphics processing functions that are required. However, time sharing alone may not be able to provide sufficient independence and isolation between the different sub-systems that may require graphics processing. Alternatively, a completely separate graphics processor could be provided for each graphics processing function that is required. However, this may have negative implications, e.g. in terms of the number of processing components and/or cost required, as it would require the division of resources to be fixed at SoC (system on chip) creation time.

The Applicant therefore believes that there is room for improved data processing system arrangements in this regard.

### BRIEF DESCRIPTION OF THE DRAWINGS

Embodiments of the technology described herein will now be described by way of example only and with reference to the accompanying drawings, in which:

FIG. 1 shows schematically a data processing system according to an embodiment of the technology described herein;

FIG. 2 shows schematically an embodiment of a graphics processor (graphics processing unit) (GPU);

FIG. 3 shows an example of how the graphics processor (graphics processing unit) (GPU) of FIG. 2 can be configured as respective partitions;

FIG. 4 shows another example where the graphics processor (graphics processing unit) (GPU) of FIG. 2 is configured into different partitions;

FIG. 5 shows schematically fault detection testing that the graphics processor may undergo;

FIG. 6 shows further details of an access manager within the graphics processor (graphics processing unit) (GPU);

FIG. 7 shows further details of internal signalling within the graphics processor (graphics processing unit) (GPU);

FIG. 8 and FIG. 9 shows an example of fault detection management that can be performed according to an embodiment;

FIG. 10 and FIG. 11 show further examples of fault detection management that can be performed according to an embodiment; and

FIG. 12 is a flow chart illustrating an embodiment.

Like reference numerals are used for like components where appropriate in the drawings.

### DETAILED DESCRIPTION

A first embodiment of the technology described herein comprises a data processing system comprising:
a graphics processor that is operable to perform processing work for one or more virtual machines, the graphics processor comprising:
a plurality of processing elements including:
   a set of plural processing (shader) cores; and
   a set of two or more scheduling units, each scheduling unit operable to schedule processing work to processing (shader) cores within the set of plural processing (shader) cores, each scheduling unit thus operable to provide a respective virtual machine interface for the graphics processor,
      wherein the plurality of processing elements within the graphics processor are configurable as different, respective “partitions” of the processing elements, each partition of processing elements (at least) including one or more processing (shader) cores from the set of plural processing (shader) cores and a respective one of the scheduling units,
      wherein at least some of the plurality of processing elements within the graphics processor are operable to undergo fault detecting testing to detect potential faults affecting those particular processing elements, and
wherein the data processing system further comprises:
fault detection circuitry that is operable and configured to identify and/or manage potential faults within particular, respective partitions of the processing elements within the graphics processor.

A second embodiment of the technology described herein comprises a method of operating a data processing system that comprises:
a graphics processor that is operable to perform processing work for one or more virtual machines, the graphics processor comprising:
a plurality of processing elements including:
   a set of plural processing (shader) cores; and
   a set of two or more scheduling units, each scheduling unit operable to schedule processing work to processing (shader) cores within the set of plural processing (shader) cores, each scheduling unit thus operable to provide a respective virtual machine interface for the graphics processor,
      wherein the plurality of processing elements within the graphics processor are configurable as different, respective “partitions” of the processing elements, each partition of processing elements (at least) including one or more processing (shader) cores from the set of plural processing (shader) cores and a respective one of the scheduling units;
the method comprising:
for a particular configuration of the graphics processor into respective first, safety critical partition and a second, non-safety critical partition:
identifying that there is a potential fault affecting one of the processing elements within the graphics processor;
identifying which of the first and second partitions include the processing element having the potential fault; and
determining a respective fault management operation, if any, that is to be performed based on whether the processing element having the potential fault is included in the first or the second partition.
   The technology described herein relates to graphics processors (graphics processing units) (GPUS) that can be configured (and re-configured) as respective different “partitions” of the processing elements within the graphics processor.

As will be discussed further below, this can then provide a graphics processor for carrying out processing tasks for virtual machines in which the processing elements within the graphics processor can be allocated and organised for use by (different) virtual machines in a flexible and adaptable manner.

Thus, the graphics processor can be, and in embodiments is, used to perform different processing operations by the different partitions, and the partitioning of the graphics processor is in embodiments configured to provide appropriate (hardware) isolation between these processing operations.

For instance, the data processing system that the graphics processor is a part of in embodiments further comprises a controller (circuit) that is operable to allocate processing elements of the graphics processor into the different, respective partitions of processing elements. This controller (circuit) is thus operable to allocate and organise the processing elements within the graphics processor according to different configurations, as desired, and in embodiments to vary that allocation in use. The controller (circuit) in embodiments also ensures that the different partitions remain sufficiently separate.

This controller (circuit) may reside at least in part within the graphics processor such that it can directly exchange signals/messages with the individual processing elements within the graphics processor. For example, the graphics processor may, and in embodiments does, comprise an access manager (unit) that is operable to communicate with the various processing elements within the graphics processor, and the access manager (unit) may comprise a suitable microcontroller or processor that is operable to (e.g., execute software to) perform the allocation and organisation of the processing elements within the graphics processor according to different configurations. In that case, the controller (i.e. access manager (unit)) may also typically communicate with a higher level (system) controller that is external to the graphics processor.

Alternatively, the controller that allocates and organises the processing elements within the graphics processor could reside outside of the graphics processor. For example, in embodiments the allocation and organisation of the processing elements within the graphics processor according to different configurations is performed by software executing on the host processor, e.g., and in particular, by the driver for the graphics processor. Thus, in embodiments, the controller (circuit) resides on a host processor of the data processing system that the graphics processor is a part of. In that case, a local access interface (e.g. the access manager (unit)) may be provided within the graphics processor that is operable to route signals/messages between the external controller and the individual processing elements within the graphics processor, as appropriate, according to the desired configuration of the processing elements within the graphics processor.

Various arrangements would be possible in this regard.

Thus, the technology described herein can, and in embodiments does, support internal (hardware) separation between different partitions within the graphics processor, whilst still allowing the graphics processor to be flexibly configured (and re-configured) to support different processing operations, with the configuration of the partitions being managed (by the controller) as appropriate, e.g. depending on the processing operations that are to be performed by the different partitions. For example, in this way, it is possible to flexibly and adaptably divide the processing elements of the graphics processor between a, e.g. “safety critical” partition and a non-safety critical partition, and for these partitions to be effectively isolated from each other (and this is what is in embodiments done).

A respective partition of the graphics processor may thus generally comprise and suitable and desired subset of the processing elements within the graphics processor.

For example, the graphics processor will have a set of plural processing (shader) cores and respective ones (or groups) of these processing (shader) cores can thus be divided between the partitions as desired, e.g. depending on the particular processing operations that the partitions are to perform. Thus, a first partition may be configured to have a first subset of the processing (shader) cores from the set of plural processing (shader) cores within the graphics processor, and a second partition may be configured to have a second subset of the processing (shader) cores, with each partition having a unique (non-overlapping) subset of the processing (shader) cores.

Various arrangements would be possible in this regard. For example, the processing (shader) cores could be divided equally between the partitions, but the processing (shader) cores could also be divided non-equally, e.g. so that one partition has a greater processing capability than another partition.

In addition to the processing (shader) cores, the graphics processor will also have various ‘ancillary’ processing elements that are shared between plural processing (shader) cores, and these ancillary processing elements may therefore also be suitably divided between the different partitions.

An example of such an ancillary processing element would be a “scheduling” unit (e.g. a job manager/command stream frontend) that provides a respective virtual machine (software) interface for the graphics processor, and that is operable to schedule processing work to respective ones of the processing (shader) cores. For example, the scheduling unit may be operable in this regard to divide a processing task allocated to the graphics processor into subtasks and distribute the subtasks for execution to respective ones of the processing (shader) cores, e.g. in the normal manner for such (work) scheduling within a graphics processor.

In this respect, to facilitate such partitioning, the graphics processor of the technology described herein is provided with a set of two or more scheduling units, and each partition should be configured with at least one of these scheduling units, i.e. with the scheduling unit(s) within a particular partition then being operable and configured to schedule processing work to the processing (shader) cores within that partition (e.g., and in embodiments, only to the processing (shader) cores within that partition such that a scheduling unit in one partition is not able to schedule processing work to processing (shader) cores within another partition).

Thus, where there are N scheduling units (wherein N≥2), the graphics processor may generally be configured as up to N different respective partitions such that each partition has its own respective scheduling unit that is operable to provide a respective virtual machine (software) interface for, and to schedule processing work to, the processing (shader) cores within that partition.

On the other hand, if the graphics processor is configured as fewer than N different respective partitions, some of these scheduling units may therefore be unused or used redundantly, as desired.

Thus, a first partition may be configured to have a first subset of the processing (shader) cores from the set of plural processing (shader) cores within the graphics processor and a first one of the scheduling units. A second partition may then be configured to have a second (unique) subset of the processing (shader) cores and another one of the scheduling units. The graphics processor may subsequently be reconfigured, e.g. so that the first one of the scheduling units is included into a partition with a different subset of the processing (shader) cores from the set of plural processing (shader) cores, and so on.

Another example of such an ancillary processing element that may be shared between plural processing (shader) cores would be a “tiler” unit that is operable and configured to perform tiling operations, e.g. as part of a tile-based rendering process.

In embodiments, the graphics processor of the technology described herein supports tile-based rendering.

Thus, in embodiments, the graphics processor of the technology described herein is also provided with a set of plural tiler units that can similarly be divided between different partitions. In that case, the number of tiler units is in embodiments (at least) the same as the number of scheduling units, such that each partition can be, and in embodiments is, configured with its own tiler unit.

However, it may not be necessary that each partition has its own tiler unit, and the number of tiler units may in some embodiments generally be fewer than the number of scheduling units. Further, if the graphics processor does not need to support tile-based rendering, there may be no tiler units (or any tiler units that are present may be powered down).

In general the graphics processor may include any other suitable and desired ancillary processing elements, e.g. that a graphics processor might typically or desirably have, and these may be partitionable in any suitable manner.

In the normal manner for graphics processor operation, the graphics processor may be used to perform (graphics) processing work for one or more virtual machines (software applications) that are executing on a host processor (e.g. CPU) of the data processing system that the graphics processor is a part of.

Thus, the host processor (e.g. CPU) will typically be executing one or more applications, and may trigger the graphics processor to perform some (graphics) processing work, as needed, with the graphics processor thus acting as an accelerator for that processing work.

In general, there may be various different processing operations that need to be performed by the graphics processor, potentially for different virtual machines, and it may be desired, e.g. for formal safety requirements, for these processing operations to be performed independently of each other. The partitioning of the graphics processor according to the technology described herein thus in embodiments allows the graphics processor to support this, with different partitions being used to perform different processing operations, and with the partitioning providing effective hardware isolation between the different partitions such that the different processing operations can be performed suitably independently.

Thus, in embodiments, as alluded to above, different partitions may be used to perform processing work with different levels of safety requirements, for example, such that a first partition is used to perform safety critical processing work whereas a second partition is used to perform non-safety critical processing work.

That is, at least in embodiments, the available processing elements are divided into two (or more) partitions, with one of the partitions intended to be used and operated within a “safety critical” domain (this partition accordingly being referred to herein as a “safety critical partition”), and another of the partitions intended to be used for and operable in a non-safety critical domain (i.e. a “non-safety critical partition”).

In order to support this operation, the graphics processor (data processing system) in embodiments includes, and can implement, one or more “fault protection” mechanisms so as to be able, for example, to provide the appropriate levels of integrity for the processing elements at least when they are operating in and for a safety-critical domain.

In the technology described herein, as will be discussed further below, the fault protection comprises providing and performing some form of “fault detection testing” (or monitoring) (or not, e.g. in the case of a lower level of protection), without necessarily, and without requiring, also (actively) preventing faults from happening in the first place. Thus, at least some of the processing elements within the graphics processor are operable to undergo suitable “fault detection testing”.

The graphics processor of the technology described herein thus further comprises appropriate fault detection circuitry to support such fault detection testing.

This fault detection circuitry of the technology described herein may generally reside at any suitable location or locations within the data processing system. In embodiments, fault detection circuitry may be distributed throughout the data processing system.

For example, as mentioned above, the graphics processor in embodiments comprises an access manager (unit) that is operable to configure or set the graphics processor into its respective, different partitions and to control access to the individual processing elements within the graphics processor, e.g. according to the configuration of the graphics processor. To facilitate this, the access manager (unit) is thus in embodiments operable to exchange status/control signals with the individual processing elements within the graphics processor.

In particular, as will be explained further below, the access manager (unit) of the graphics processor in embodiments comprises an error status reporting circuit that is operable to receive “error” status signals from the individual processing elements within the graphics processor (the error status reporting circuit thus comprising part of the fault detection circuitry). The access manager (unit) of the graphics processor is in embodiments also operable to issue suitable control signals (e.g. a reset signal) to the individual processing elements within the graphics processor, e.g. to perform desired fault management operations.

At least some of the fault detection circuitry of the technology described herein may thus reside within the graphics processor, e.g., and in embodiments, within such access manager (unit) that is operable to communicate with the individual processing elements within each of the different, respective partitions of the graphics processor (the access manager (unit) therefore not being included into any one of the partitions but instead effectively being shared between the different, respective partitions).

Each of the individual processing elements within the graphics processor may also comprise (local) fault detection logic (circuitry) that is operable to generate the “error” status signals mentioned above and to act on the control signals provided by the access manager (unit).

As mentioned above, there may further be an external (system) controller that allocates and organises the processing elements within the graphics processor according to the different configurations, and in some embodiments the fault detection circuitry may reside in part in the (same) (e.g. system) controller that allocates and organises the processing elements.

In general, however, the fault detection circuitry could be separate from the controller (and/or access manager) and various arrangements are contemplated in that regard.

According to the technology described herein the fault detection circuitry is particularly operable and configured to identify potential faults within particular, respective partitions of the processing elements. The fault detection circuitry is in embodiments also operable and configured to manage potential faults within particular, respective partitions of the processing elements.

That is, in the technology described herein, fault detection reporting and management can be (and is) performed on a per-partition basis (e.g. rather than this been performed globally for the graphics processor as a whole).

This can then provide an improved operation, in particular by allowing fault detection and management to be performed in a finer-grained fashion wherein the data processing system (fault detection circuitry) is operable to determine how to manage faults affecting a particular respective partition of the graphics processor, e.g., and in embodiments, whilst allowing other partitions of the (same) graphics processor that are not affected by the fault to continue their processing.

For example, in response to detecting a potential fault affecting one or more processing elements within a graphics processor in a more traditional system, an appropriate fault management operation may in some cases be to reset the graphics processor, or (at least temporarily) take the graphics processor offline. This may be particularly so when the graphics processor is performing safety critical processing as in that case it is important to ensure the processing output is correct such that any detected faults should be appropriately managed. If the graphics processor is reset, any (and all) virtual machines executing on the graphics processor will then need to restart their processing jobs, and this can cause processing glitches.

Therefore, if the graphics processor is (only) performing non-safety critical processing, the Applicant recognises that in that case it may be desirable to simply allow the processing to continue. For example, for typical non-safety critical (graphics) processing applications, much of the data that is generated will be overwritten so that any errors may be not visible or at least not perceptively visible. Thus, if the errors can be tolerated, it may be acceptable, and better, to allow the processing to continue (i.e. to essentially ignore the fault) to avoid more noticeable processing glitches.

When the graphics processor is operable to perform a mixture of safety critical and non-safety critical processing, as may be the case for the graphics processor of the technology described herein, this may however create various issues.

For instance, if there is a chance that fault is affecting the safety critical processing, the appropriate action may be to reset the graphics processor. Accordingly, in a naïve approach, detecting a potential fault in any processing element could always trigger a global reset of the graphics processor. However, if the fault is in fact only affecting the non-safety critical processing, this may be unnecessary. Further, more significantly, the non-safety critical processing should not be able to corrupt or interrupt the safety critical processing, and so this naïve approach may not ensure sufficient isolation between safety domains.

According to the technology described herein, therefore, as mentioned above, the fault detection and management can be (and is) performed on a per-partition basis.

For instance, in this way, the fault detection testing may be, and in embodiments is, selectively enabled (or not enabled) in respect of individual processing elements within the graphics processor and the decision as to whether or not to enable the fault detection testing is in embodiments made based on which partition the processing elements are included into, e.g., and in particular, based whether those processing elements are included within a safety critical or non-safety critical partition.

This then avoids the need to have to configure the processing elements to operate permanently at a higher level of fault protection (which may have a cost in terms of performance, energy consumption and/or die area), whilst still allowing the processing elements to be flexibly and adaptably configured into both safety critical and non-safety critical partitions, and being able to provide appropriate levels of fault protection (integrity) to a processing element when that is desired (e.g. it is included in a safety critical partition).

(It will be appreciated here that the controller and the access manager (unit) associated with the graphics processor are in embodiments configured to operate with a higher level of fault protection at all times, but the partitions of processing elements can be controlled to operate with different levels of fault protection, as appropriate.)

Thus, the fault detection circuitry is in embodiments operable and configured to selectively enable (or disable) the fault detection testing in respect of processing elements within the respective, different partitions of processing elements. This may be done as part of the setting/configuring of the graphics processor into the respective, different partitions (e.g. by the controller and/or access manager (unit)).

In this regard, it will be appreciated that it should be possible to enable or trigger the fault detection testing in respect of individual ones of the processing elements (since these may be configured into any different partitions, as discussed above) (and so this is in embodiments the case). However, a determination as to whether or not fault detection testing should be enabled in respect of a particular processing element is in embodiments made on a partition-by-partition basis, e.g. based on whether the processing element is included into a safety critical or non-safety critical partition.

For instance, it will be appreciated that it may not generally be necessary to perform fault detection testing for any processing elements in a non-safety critical partition. Therefore, in embodiments, fault detection testing is not enabled (i.e. or disabled) for at least some of the processing elements in a non-safety critical partition. In some embodiments, fault detection testing is disabled (i.e. or not enabled) for any/all of the processing elements in a non-safety critical partition, as this is not necessary, and will have an associated cost in terms of performance and/or energy consumption.

Nonetheless, it may still be desired in some cases to enable fault detection testing for some processing elements in a non-safety critical partition. An example of this would be when there is a known manufacturing defect affecting a particular processing element, in which case enabling the fault detection testing may allow that processing element to still be used (e.g. rather than having to take the defective processing element completely offline). That is, in some cases, fault detection testing may be enabled to mitigate known manufacturing defects, and in this way it may be possibly to effectively increase manufacturing yield, i.e. by allowing defective processing elements to still be used (rather than potentially having to discard the entire chip or sell the chip as a reduced function chip).

Thus, for a non-safety critical partition, fault detection testing may be disabled (i.e. not enabled) for some or all of the processing elements that are included into the non-safety critical partition.

On the other hand, fault detection testing should generally always be enabled for all of the processing elements in a safety critical partition (or at least all of the processing element for which the fault detection testing can be enabled for), and so this is in embodiments done.

In embodiments, the decision as to whether (or not) fault detection testing should be enabled in respect of one or more processing elements can thus be performed based at least in part on which partition those processing elements are included within.

For instance, the fault detection circuitry (the controller and/or access manager (unit)) is in embodiments operable and configured to identify whether fault detection testing should be performed for a particular, respective partition (e.g. based on it being a safety critical partition) and, if so, selectively enable the fault detection testing for some and in embodiments all of the processing elements within that particular, respective partition.

Thus, when the plurality of processing elements are configured into different, respective partitions such that there is at least one safety critical partition and at least one non-safety critical partition, the fault detection circuitry (the controller and/or access manager (unit)) is in embodiments configured to enable the fault detection testing for all processing elements that are able to undergo the fault detection testing within the safety critical partition. Whereas, the fault detection circuitry (the controller and/or access manager (unit)) does not need to enable the fault detection testing for all processing elements within the non-safety critical partition, and so in embodiments does not do this.

This can then improve performance in particular by allowing fault detection testing to be selectively disabled when it is possible to do so, e.g. for non-safety critical partitions. Thus, the fault detection testing is in embodiments configurable, and this can in embodiments be done for individual processing elements, but based on which partitions those individual processing elements are included within.

For instance, as mentioned earlier, it will be appreciated that the fault detection testing will have an associated cost in terms of performance and/or power consumption.

In this respect, the fault detection testing that is performed may generally comprise any suitable and desired fault detection testing.

For example, the configurable fault detection testing may use one or both of built-in self-testing (BIST) or software test library (STL) testing, in particular where the processing unit is to be periodically tested (such that it is temporarily unavailable to perform its normal processing operations). Such built-in self-testing (BIST) or software test library (STL) testing may take any suitable form. For example, in the case where built-in self-testing (BIST) is used, this could comprise logic built-in self-testing (LBIST) and/or memory built-in self-testing (MBIST). This testing may thus be performed periodically which will therefore have an associated cost in terms of performance and/or (overall) energy consumption.

In embodiments, however, the configurable fault detection testing comprises “runtime” (or “mission mode”) testing. That is, in embodiments, the configurable fault detection testing is implemented and supported within the graphics processor (hardware) such that, when fault detection testing is enabled for a particular processing element, the fault detection testing is performed alongside or as part of the normal operation of the processing element in question.

An example of this runtime (mission mode) testing would be using an error detection and/or correction memory protection scheme that is operable to detect, and optionally correct, one or more bit errors affecting internal memory elements (e.g. RAMs) within the graphics processor. In this case, the error detection and/or correction memory protection scheme, when enabled in respect of a particular memory element or elements, essentially serves to protect each access to those memory element(s) that is performed during the normal operation of the processing element. Various examples of such error detection and/or correction memory protection schemes exist that may be used in this regard. For instance, single bit errors may be detected with a parity bit, but various more sophisticated error correcting codes (ECC) also exist that may be used to provide appropriate memory protection. For example, extended Hamming codes may be used to provide single error correction double error detection (SECDED).

Another example of runtime (mission mode) testing that could be used would be a modular redundant scheme in which processing is run in multiplicate. For example, in a dual modular redundancy (DMR) scheme, processing may be run in duplicate, and this will allow potential errors to be detected (i.e. if the output of the same processing is different). In a triple modular redundancy (TMR) scheme, it may also be possible to correct errors (i.e. based on a majority vote).

Thus, the fault detection testing that the processing elements can undergo in the technology described herein in embodiments comprises one or both of:
a modular redundancy scheme in which at least some processing is performed in multiplicate; and
an error detection and/or correction memory protection scheme.

It will be appreciated that these types of “runtime” (mission mode) fault detection testing schemes may have particularly increased cost in terms of performance and/or energy consumption since, when such schemes are enabled, the fault detection testing is effectively always on, and runs alongside or as part of the normal operation of the processing element.

Therefore, it may be particularly beneficial to be able to enable and manage this type of fault detection testing on a per-partition basis within the graphics processor (and the technology described herein facilitates this).

In cases where fault detection testing is enabled, the fault detection circuitry is in embodiments also configured to trigger (appropriate) action in the event of a fault (or threshold level of faults, for example) being detected. This could comprise, for example, performing some form of error recovery operation, and/or reporting the fault to another component of the system, for handling. In embodiments some action is taken to protect against the consequences of the detected fault(s).

The fault detection circuitry of the technology described herein is in embodiments therefore also operable to report and manage faults on a partition-by-partition basis.

For example, in the event of a fault, one or more partitions within the graphics processor may, e.g., be reset, and/or may enter a particular fault recovery operation. The operation in the event of a fault being detected may, e.g., be specified for the (partitions of the) graphics processor for the data processing system in question (e.g. there may be a predefined fault recovery operation), and/or able to be set in use.

Thus, in response to the fault detection testing detecting a potential fault affecting a particular processing element within the graphics processor, the (local) fault detection testing (logic) within that processing element may generate an appropriate “error” signal to indicate to the fault detection circuitry (e.g. within the access manager (unit) and/or controller) that there is a potential fault affecting that particular processing element. The fault detection circuitry (within the access manager (unit) and/or controller) can thus determine that there is a fault affecting the partition that includes that particular processing element and then perform an appropriate fault recovery operation in respect of that partition (without necessarily having to take any action in respect of other partitions, i.e. that are not affected by the fault).

In the technology described herein, these “error” signals are in embodiments generated in respect of individual processing elements (for which the fault detection testing is enabled). However, as discussed above, the fault management is in embodiments performed on a per-partition basis.

Thus, the fault detection circuitry is operable to receive, in respect of an individual processing element within the graphics processor, a respective error signal indicating that there is a potential fault affecting that processing element. In embodiments, the fault detection circuitry is operable to receive error signals from each (and any) of the individual processing elements within the graphics processor (or at least each of the processing elements that are operable to undergo fault detection testing). This then provides greater flexibility as the fault detection circuitry is able to receive “error” status signals from any processing elements, regardless of how the graphics processor is configured. However, other arrangements would be possible. For example, error signals from multiple different processing elements could be routed through a same particular processing element.

In response to the fault detection circuitry receiving such an error signal indicating that there is a potential fault affecting a particular processing element within the graphics processor, the fault detection circuitry is in embodiments then further operable and configured to identify which respective partition includes the processing element having the potential fault. In embodiments, it is then signalled to an appropriate controller for the graphics processor (which could be the access manager, or another higher level (system controller) that there is a potential fault affecting the identified partition.

For example, an appropriate error status register for that partition can then be updated accordingly to indicate that there is a potential fault affecting the identified partition. Each partition may have its own error status register. These error status registers may then be reported upwards, e.g. to a higher level (system controller), as needed.

This is in embodiments done by an appropriate error status reporting circuit of the fault detection circuity. This error status reporting circuit in embodiments resides within the graphics processor, e.g., and in embodiments, within the access manager (unit).

Thus, the error status reporting circuit of the fault detection circuitry (which in embodiments resides within the access manager (unit) of the graphics processor) may receive error signals from various processing elements, and is then operable and configured to process and group these error signals according to the current graphics processor configuration, i.e. such that detected faults can be flagged/reported for respective, different partitions of the graphics processor, and on a partition-by-partition basis (rather than for individual processing elements or for the graphics processor as a whole).

For example, the error status reporting circuit of the fault detection circuitry, in response to detecting a fault, in embodiments then reports this fault to a higher level (system) controller (e.g. which may reside on the host software driver), and this reporting is in embodiments performed on a per-partition basis, so that any detected faults can then be managed accordingly on a partition-by-partition basis.

This can then allow faults to be managed on a partition-by-partition basis, and in particular so that faults can be managed independently, and as appropriate, for different partitions, e.g., and in embodiments, based on whether the fault is affecting a safety critical partition or a non-safety critical partition.

For example, fault detecting testing should generally be performed for all processing elements within a safety critical partition, and in the event that a potential fault is detected affecting a processing element within a safety critical partition, appropriate fault management should then be performed to mitigate the potential fault.

In some cases, however, fault detection testing may also be performed for at least some processing elements that are within non-safety critical partitions.

This could be because the fault detection testing is always enabled for the processing element (or graphics processor (data processing system)) in question. Or this could be because the fault detection testing has been enabled in respect of those processing elements despite them residing in a non-safety critical partition. There are various reasons why this might be done but one example would be where the processing element is known to be defective, and so the fault detection testing scheme is enabled to allow the defective faulty processing element to be (more) effectively used, as above.

As mentioned above, in the event that a potential fault is detected that is (only) affecting a processing element within a non-safety critical partition, it may be possible, and beneficial, to ignore the fault and allow the non-safety critical partition to continue its processing.

Thus, the appropriate fault management that is performed may depend on whether the fault is affecting a processing element within a safety critical partition or a non-safety critical partition.

For example, if there is a fault identified that is affecting processing elements (only) within a partition that is performing non-safety critical processing, in that case it may be acceptable to effectively ignore the fault as it may be acceptable to tolerate errors within the non-safety critical processing (i.e. because it is non-safety critical, as discussed above).

Thus, in embodiments, the plurality of processing elements are configured into different, respective partitions such that there is at least one safety critical partition and at least one non-safety critical partition, and the fault detection circuitry is operable to, in response to identifying that there is a potential fault that is only affecting a processing element within a non-safety critical partition, but not affecting any processing elements within any safety critical partition, allow the non-safety critical partition to continue its processing.

In this case, the fault detection circuitry may, for example, simply report the fault (e.g. to a higher level (system) controller) but no particular action may otherwise be triggered at this point to mitigate the fault, with the non-safety critical partition simply allowed to continue its processing.

In some embodiments, in this case, fault detection testing could then be selectively enabled for the particular processing element that has the potential fault (but this is not necessary). Similarly, the processing element could subsequently be taken offline, e.g. for further testing, but this need not be done.

Further, any other partitions that are unaffected by the fault also continue their processing as there is no need to reset the graphics processor globally. This means that even when the graphics processor is performing some safety critical processing (in one partition), so long as the fault detection circuitry can identify that the fault does not affect any of the processing elements with the safety critical partition, the safety critical partition can also continue its processing.

On the other hand, if there is a fault identified that is affecting one or more processing elements within a partition that is performing safety critical processing, appropriate fault management should then be performed (and so in embodiments is performed), e.g. to reset that partition. Again, however, in this case, it is only the affected partition (and any virtual machines using that particular partition) that needs to be reset, and any other partitions can continue their processing.

Thus, in embodiments, the plurality of processing elements are configured into different, respective partitions such that there is at least one safety critical partition and at least one non-safety critical partition, and the fault detection circuitry is operable to, in response to identifying that there is a potential fault that is affecting a processing element within a safety critical partition, trigger resetting the partition and/or the virtual machine using that partition.

The ability to configure and re-configure the graphics processor into different respective partitions of processing elements provides further opportunities in this regard. For example, if there is a fault identified in a processing element that is currently within a safety critical partition, which may therefore require managing, the controller (or access manager) may re-configure the graphics processor to move the faulty processing element into another (non-safety critical) partition. For example, the faulty processing element could be swapped with a corresponding functioning processing element from the other (non-safety critical) partition.

Thus, in embodiments, the data processing system is further operable to, in response to the fault detection circuitry identifying that there is a potential fault that is affecting a processing element within a safety critical partition, trigger re-configuring the graphics processor into different, respective partitions of the processing elements such that the processing element having the fault is moved to a non-safety critical partition.

In this regard, the fault detection circuitry (and/or a higher level (system) controller) may be operable to (try to) determine whether the potential fault is a “soft” error (i.e. which may be resolved by re-setting the partition) or a “hard” error (which will not). For example, a “hard” error may be detected if a processing element continues to generate errors. Based on determining that there is a “hard” error, the fault detection circuitry (and/or a higher level (system) controller) may then trigger re-configuring the graphics processor into different, respective partitions of the processing elements and/or disabling the processing element having the fault. Thus, the fault detection circuitry (and/or a higher level (system) controller) may initially trigger re-setting the partition, and only if the fault remains, then trigger re-configuring the graphics processor into different, respective partitions of the processing elements and/or disabling the processing element having the fault, as appropriate.

In embodiments, therefore, the data processing system is further operable to, in response to the fault detection circuitry identifying that there is a potential fault that is affecting a processing element within a safety critical partition, determine whether the potential fault is due to a hard error, and in that case trigger re-configuring the graphics processor into different, respective partitions of the processing elements such that the processing element having the fault is moved to a non-safety critical partition.

Additionally/alternatively, in response to determining that there is a hard error, the processing element having the fault may be disabled (powered down).

Various arrangements would be possible in this regard.

The technology described herein therefore provides a configurable graphics processor wherein the graphics processor can be configured as different respective partitions of the graphics processor in order to more flexibly support different (independent) processing operations and in which fault management can be, and in embodiments is, performed in an improved (finer-grained) manner, e.g., and in embodiments, so that faults can be identified and/or managed on a partition-by-partition basis, as above.

Subject to the requirement to be operable in accordance with the technology described herein, the graphics processor may otherwise comprise any or all of the normal components, functional units, and elements, etc., that such a graphics processor may comprise.

For instance, as mentioned above, the graphics processor includes a set of plural processing (shader) cores for executing programs to perform processing work. In general the graphics processor may include any suitable and desired number and arrangement of processing (shader) cores.

Similarly, each processing (shader) core may otherwise comprise any or all of the normal components, functional units, and elements, etc., that such a processing (shader) core may comprise. Each processing (shader) core may have the same set of functional units, etc., or some or all of the processing (shader) core may differ from each other.

In some embodiments, the processing (shader) cores may be grouped into respective processing (shader) core groups that share some processing resources (such as a shared cache (e.g. a level 2 cache portion) that provides an interface to an external (main) system memory of the data processing system). In that case, the partitioning of the graphics processor is in embodiments performed in respect of these processing (shader) core groups (i.e. such that all of the processing (shader) cores within a group, together with any shared resources for that processing (shader) core group have to be assigned to the same partition).

Various arrangements would be possible in this regard.

The graphics processor also includes a set of plural “scheduling” units, as discussed above, that provide the appropriate virtual machine (software) interfaces to the graphics processor, and that are operable to schedule processing work to the processing (shader) cores. These scheduling units may take any suitable and desired form. For example, these scheduling units may be in the form of a suitable “job manager” and/or “command stream frontend”.

In an embodiment, the graphics processor is a tile-based graphics processor, and so the processing elements of the graphics processor also include one or more tiling unit (a tiler or hierarchical tiler). In embodiments, the graphics processor may include plural tiling units, such that different partitions can be configured with respective, different tiling units.

The graphics processor may, and in embodiments does, also comprise one or more of, and in embodiments all of: one or more cache (e.g. one or more level 2 (L2) cache or L2 cache portions/slices) that provides an interface to an external (main) system memory of the data processing system, and one or more memory scheduling unit (MMU) (however, appropriate memory scheduling units could also or instead be located externally to the graphics processing unit or units, if desired).

The data processing system that the graphics processor is a part of also comprises a controller that that allocates and organises the processing elements according to the desired partitions. This controller may reside at least in part within the graphics processor or may be external thereto. At least when the controller is external to the graphics processor, the graphics processor in embodiments further comprises an access manager (unit) that controls access to the processing elements of the graphics processor according to the respective partitions into which the graphics processor is configured.

The controller is thus in embodiments operable to manage and enforce the partitioning of the graphics processor to ensure the independent operation of the different partitions, and this is in embodiments facilitated by the access manager (unit), where this is provided. For instance, the access manager of the graphics processor may be, and in embodiments is, operable to exchange signals/messages with the individual processing elements within the graphics processor to control their operation, but this may be done under the overall control of a higher level (system) controller that is external to the graphics processor (e.g. this controller may be implemented in software executing on the host processor, as above).

The processing elements (within the graphics processor) can be allocated to respective partitions of processing elements in any suitable and desired arrangement and distribution. The processing elements should be and are in embodiments arranged as plural (separate) partitions of processing elements. In one embodiment, there are two partitions of processing elements, but it would be possible to have more than two partitions of processing elements, if desired.

Each partition of processing elements can contain any suitable and desired number of processing (shader) cores. The partitions could each contain the same number of processing (shader) cores, but that is not essential, and different partitions may contain different numbers of processing (shader) cores, as desired. For example, one partition could contain a single processing (shader) core (or single group of processing (shader) cores), with another partition containing plural processing (shader) cores (or groups thereof).

The distribution of the available processing elements as between different partitions of those processing elements can be determined and set in any suitable manner. This may, and is in embodiments, done, for example, based on and in embodiments to match the processing performance requirements of the system in question. For example, in the case of graphics processing, partitions that are intended to handle more complex graphics generation (e.g. for entertainment purposes) may be assigned more processing (shader) cores to meet the performance needs, while groups handling more simple graphics processing requirements (e.g. for a control panel) may be assigned fewer processing (shader) cores. An advantage of the technology described herein is that the distribution of processing elements to groups in the technology described herein can be done flexibly and can be changed, by software or firmware, in use, depending upon the kind of system and application that the graphics processor is being used for.

Each partition of processing elements should, and in embodiments does, comprise different processing elements of the plurality of processing elements to all of the other partitions of processing elements. Thus there should be, and is in embodiments, no sharing of processing elements between the different partitions of processing elements. Correspondingly, each partition of processing elements will comprise its own unique and exclusive set of one or more processing elements, that does not share any processing elements with any of the other partitions of processing elements that have been assigned.

Thus, in an embodiment, the controller is operable to (e.g. logically) separate the plural processing elements into plural (e.g. two) partitions, wherein each group comprises a respective subset of the processing elements, and the plural partitions are distinct from each other, i.e. each processing element belongs to only one partition.

In an embodiment, the plural groups comprise a first partition comprising a first set of the processing elements that may be, and is in embodiments, reserved for and used by a first set of one or more virtual machines that require a first type of data processing to be carried out, and a second partition comprising a second set of processing elements that may be, and is in embodiments, reserved for and used by a second set of one or more virtual machines that require a second type of data processing to be carried out. The first type of data processing may be other than (may not comprise) safety critical data processing tasks (such as graphics processing tasks for navigation/entertainment displays, etc.). The second type of data processing may comprise safety critical data processing tasks (such as graphics processing tasks for main instrument console displays, data processing tasks for (e.g. assisting) vehicle control, etc.).

In an embodiment, the allocation of processing elements to respective partitions of processing units can be changed and varied by the controller(rather than being fixed once the controller has configured an initial allocation of processing elements to partitions). For example, in an automotive application, when reverse gear is engaged, processing elements (e.g. processing (shader) cores) being used for a navigation and/or entertainment display in a “non-safe” group may be moved to a safe “group” and used to display the reversing camera.

Thus, in an embodiment, the controller is operable to be able to move processing elements from one partition to another, e.g., and in embodiments, in response to some event that may be detected and conveyed to the controller (such as detecting a potential fault in one or more processing elements within a particular partition, e.g. as above).

Allowing the processing elements to be moved between partitions in use provides even greater flexibility.

In the case where the controller wishes to move a processing element or elements from one partition to another (to reconfigure the partitions of processing elements), there is in embodiments an appropriate “handshaking” procedure, e.g. with the virtual machines for the respective partitions, to allow any processing elements that are being moved between the partitions to be appropriately stopped and restarted (once they have moved to a different partition), and, for example, any tasks that they were performing to be appropriately suspended. This process in embodiments also includes resetting and/or powering off (and restarting) the processing elements, etc., in question.

The controller that allocates and organises the processing units into respective groups of one or more processing units can take any suitable and desired form.

The controller can operate to configure the respective partitions of processing elements in any suitable and desired manner. In an embodiment, it operates to configure a (configurable) communications network that sets the communications paths between the processing elements, and to the controller, to set the appropriate communications paths between the processing elements and to the virtual machines, so as to configure the graphics processor to have the desired configuration.

The configurable communications network may, for example, comprise a configurable interconnect and/or communications network comprising appropriate switches, and/or for which the address mapping can be configured, etc., such that respective processing elements can each independently and selectively be connected to different communication buses and/or to each other, so as to, for example, allow the processing elements to be configured into respective partitions of processing elements that are then connected “together” to a communications bus for that group of processing elements.

Thus there is in embodiments an appropriately configurable communications network, e.g. including one or more configurable interconnects, e.g. together with appropriate switches, that can be configured by the access manager to set up the desired partitions of processing elements, and the appropriate communications paths between the respective partitions of the processing elements and the virtual machines that are to use the partitions.

In an embodiment, the controller is operable and configured to ensure that the processing elements allocated to one partition of processing elements can only be accessed by the virtual machines that are allocated to that partition of processing elements (i.e. such that a (and each) partition of processing elements cannot be accessed by virtual machines that are intended to use a different partition of the processing elements). This can help, for example, to ensure that safety critical virtual machines and processing operations are separated from other virtual machines and processing operations. Thus, the processing tasks for a virtual machine can then be carried out by the partition of processing elements that that virtual machine is allocated to (and substantially in isolation from any other partition of processing elements and virtual machines).

The controller in embodiments comprises a set of configuration registers for configuring and/or controlling the partitions of processing elements, etc..

In an embodiment, the controller supports a particular, in embodiments selected, and in embodiments fixed, (total) number of partitions (subsets) that the processing elements can be divided into. For example, the graphics processor may support two partitions of the processing elements, with the controller correspondingly being operable to divide the processing elements between those two partitions. As discussed elsewhere, the controller could, e.g., however, allocate the same number of processing elements to each partition, or could allocate different numbers of processing elements to different partitions, as desired.

The graphics processor will also comprise an appropriate communications network for providing communications between the various units of the graphics processor, such as memory transactions between processing (shader) cores and/or the cache of the graphics processing unit, subtask control traffic between the scheduling unit (job manager/command stream frontend) and processing (shader) cores and so on.

Other configurations of graphics processor would, of course, be possible.

As mentioned above, the graphics processor will typically be provided as part of a larger data processing system, the data processing system including a host processor (e.g. CPU) for which the graphics processor is able to act as an accelerator.

The data processing system that the graphics processor is part of may comprise any suitable processing units, controllers, arbiters, virtual machines (and their host processors), etc., for operation in the manner of the technology described herein. The data processing system may also include any other suitable and desired components, elements, units, etc., that a data processing system may comprise.

Thus, the data processing system may, e.g., include one or more peripheral devices, such as one or more output devices (e.g. display screens, vehicle controllers, etc.), and/or one or more input devices (e.g. human-computer interfaces, vehicle sensors, etc.). The virtual machines (host processors) may have access to the same set of one or more peripheral devices, or, e.g., a separate set of peripheral devices may be provided for different groups of virtual machines (again, this may be beneficial for safety and/or security purposes).

The overall data processing system in embodiments includes appropriate (system) memory for storing the data used by the graphics processor (and any other processing units when carrying out processing and/or for storing the data generated by the graphics processor (or other processing units) as a result of carrying out processing.

Thus, in an embodiment, the data processing system includes the graphics processor (or plural, similar graphics processors), and one or more host data processing units (processors) (e.g. CPUs) on which one or more virtual machines execute (in embodiments together with one or more drivers (for the graphics processor(s))).

In an embodiment, the data processing system and/or graphics processor comprise, and/or are in communication with, one or more memories and/or memory devices that store the data described herein, and/or that store software for performing the processes described herein.

The technology described herein can be used for all forms of output that a graphics processor may output. Thus, it may be used when generating frames for display, render-to-texture outputs, etc.. However, the technology described herein can equally be used where the graphics processor is to be used to provide other processing and operations and outputs, for example that may not be or may not relate to a display or images. For example, the technology described herein can equally be used for non-graphics use cases such as ADAS (Advanced Driver Assistance Systems) which may not have a display and which may deal with input data (e.g. sensor data, such as radar data) and/or output data (e.g. vehicle control data) which isn't related to images. In general, the technology described herein can be used for any desired graphics processor data processing operations, such as GPGPU (general purpose GPU) operations.

In one embodiment, the various functions of the technology described herein are carried out on a single system on chip (SoC) data processing system.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and units of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising on a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

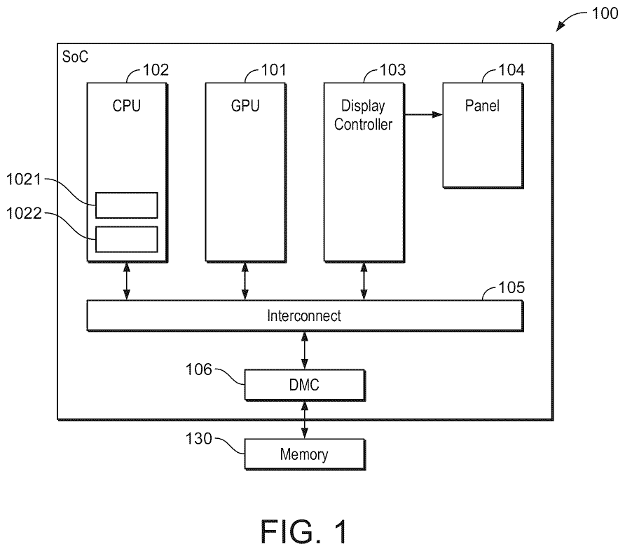

FIG. 1 shows an exemplary data processing system 100 that can be operated in accordance with the embodiments of the technology described herein.

As shown in FIG. 1, the data processing system 100 includes a central processing unit (CPU) 102, a graphics processor (graphics processing unit) (GPU) 101, and a display controller 103 (coupled to a display panel 104), that communicate via an interconnect 105. The central processing unit (CPU) 102, graphics processor (graphics processing unit) (GPU) 101, and display controller 103 also have access to off-chip memory 130 for storing, inter alia, frames to be displayed, via a memory controller 106.

In the normal manner for such data processing systems, the graphics processor (graphics processing unit) GPU 101 may be available as an accelerator for certain types of processing work. Thus, an application 1021 executing on the central processing unit (CPU) 102 may require (graphics) processing operations to be performed by the graphics processor (graphics processing unit) GPU 101. To do this, the application will generate API (Application Programming Interface) calls that are interpreted by an appropriate (software) driver 1022 for the graphics processor (graphics processing unit) GPU 101 that is running on the central processing unit (CPU) 102 and that generate appropriate commands for the graphics processor (graphics processing unit) GPU 101 to perform the processing required by the application 1021.

In use, the graphics processor (graphics processing unit) (GPU) 101 will, for example, generate for the application 1021 a sequence of frames for display, which are stored via the memory controller 106 in a frame buffer in the off-chip memory 130. Then, when the frames are to be displayed, the display controller 103 will read the frames from the frame buffer in the off-chip memory 130 via the memory controller 106 and send them to a display panel 104 for display.

Although FIG. 1 only shows a single graphics processor (graphics processing unit) (GPU) 101 it will be appreciated that the data processing system 100 may generally include more than one graphics processor (graphics processing unit) (GPU), e.g. arranged in a group, e.g. and operable either independently or in combination. Likewise the system in FIG. 1 only shows certain elements of a data processing system but the data processing system may generally contain any other desired units that a data processing system may comprise.

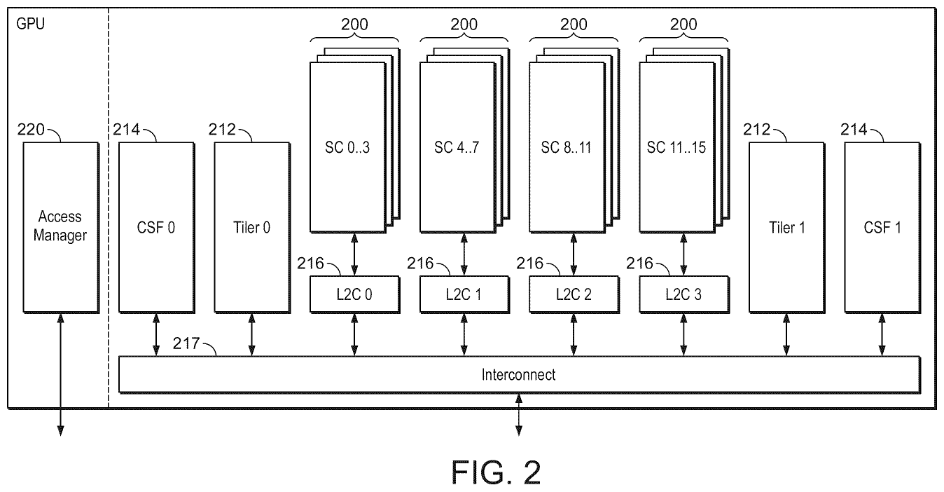

FIG. 2 shows in more detail an embodiment of a graphics processor (graphics processing unit) (GPU) (such as the graphics processor (graphics processing unit) (GPU) 101 in FIG. 1).

As shown in FIG. 2, the graphics processor (graphics processing unit) (GPU) includes plural shader (processing) cores 200 that are provided along the same interconnect 217.

In FIG. 2, the plural shader (processing) cores 200 are arranged as four respective banks of plural shader (processing) cores 200 with each bank having a respective shared (L2) cache 216 which is operable to communicate via the interconnect 217 with the off-chip memory system of the data processing system that the graphics processor (graphics processing unit) (GPU) is a part of.

The graphics processor (graphics processing unit) (GPU) also includes suitable “scheduling” units that provide the virtual machine (software) interface for the graphics processing unit and are also operable to divide a data processing task allocated to the graphics processing unit into subtasks and to distribute the subtasks for execution to the shader (processing) cores 200 of the graphics processor (graphics processing unit) (GPU). In the example shown in FIG. 2, there are two such scheduling units, each in the form of a command stream frontend (“CSF”) 214. These command stream frontends 214 are thus operable to communicate over the interconnect 217 with respective ones of the shader (processing) cores 200 to schedule processing jobs thereto.

Although not shown in FIG. 2, a shader (processing) core may thus comprise a suitable shader core “endpoint” that is operable to schedule processing work to the execution engine within the shader (processing) core and corresponding fragment thread creation circuitry that is operable to generate appropriate execution threads for execution.

A command stream frontend 214 may thus issue fragment processing jobs to the shader core endpoint of a respective shader core accordingly to cause the shader (processing) core to perform desired fragment processing work. The command stream frontend 214 may also generally be able to schedule other desired processing work for the graphics processor, including compute and neural network processing work.

In the present embodiments the graphics processor (graphics processing unit) (GPU) is operable to perform tile-based rendering and so also includes suitable tiler units 212 are again operable to communicate over the interconnect 217 with the respective shader (processing) cores 200 to perform tiling operations. In the example shown in FIG. 2, there are two separate tiling units 212.

The graphics processor (graphics processing unit) (GPU) shown in FIG. 2 thus includes a plurality of (different types of) processing elements, including the (banks of) shader (processing) cores 200, but also including various ‘ancillary’ processing elements such as suitable scheduling units (e.g. the command stream frontends 214) and tiling units 212, that communicate over the same interconnect 217 and can be used together with the shader (processing) cores 200 to perform desired processing work.

According to the present embodiments, the graphics processor (graphics processing unit) (GPU) can be configured (and re-configured) as different respective “partitions” of these processing elements.

For instance, in FIG. 2, the graphics processor (graphics processing unit) (GPU) could be considered as a single partition. In this case, where there is only a single partition, which includes all of the (banks of) shader (processing) cores 200, one of the tiler units 212 (‘Tiler 1’) and one of the command stream frontends 214 (‘CSF 1’) are unused.

Providing multiple tiler units 212 and command stream frontends 214 however supports partitioning the graphics processor (graphics processing unit) (GPU) into multiple, respective partitions, with each partition having its own different set of processing elements.

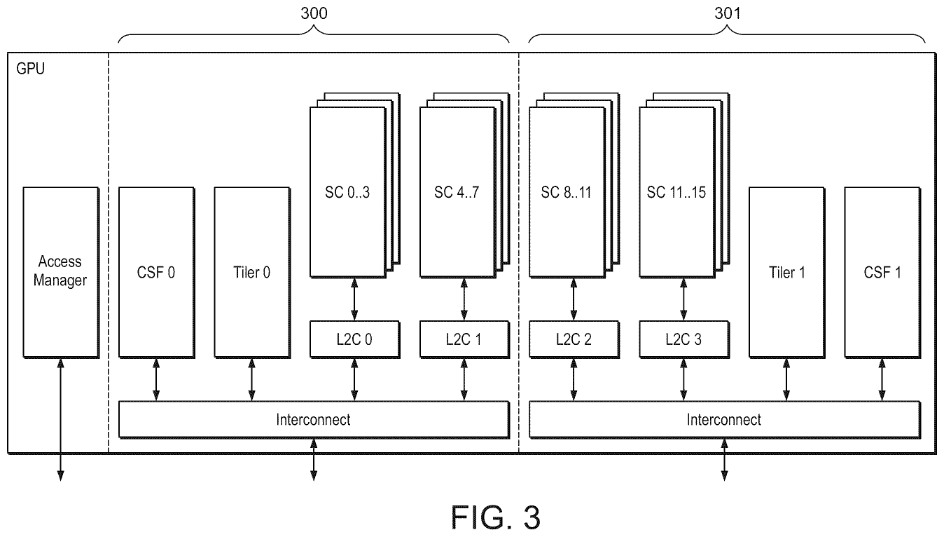

For example, FIG. 3 shows a first example in which the graphics processor (graphics processing unit) (GPU) is divided into two equal partitions. Thus, as shown in FIG. 3, the first partition includes one of the command stream frontends 214 (‘CSF0’), one of the tiler units 212 (‘Tiler 0’), half of the shader (processing) cores 200 (‘SC 0 . . . 7’), along with the respective shared (L2) caches 216 for those shader (processing) cores 200, and a respective portion of the interconnect 217. The second partition then includes the other of the command stream frontends 214 (‘CSF01), the other of the tiler units 212 (‘Tiler 1’), the other half of the shader (processing) cores 200 (‘SC 8 . . . 15’) with their respective shared (L2) caches 216, and a different respective portion of the interconnect 217.

Thus, the different partitions are effectively isolated in hardware, and so can be used to perform different and independent processing operations.

To facilitate this partitioning of the graphics processor (graphics processing unit) (GPU), an access manager 220 is provided that is operable and configured to control access to the respective processing elements according to the desired partitions. The access manager 220 thus controls the partitioning of the graphics processor (graphics processing unit) (GPU), and then controls access to the respective processing elements within each partition accordingly, i.e. to maintain the desired (hardware) isolation of the partitions.

As will be explained further below, this access manager 220 is also in communication with a higher level (system) controller (not shown), e.g. that may be coupled to the software driver 1022 for the graphics processor (graphics processing unit) (GPU) on the central processing unit (CPU) 102, and that sets the configuration of the graphics processor (graphics processing unit) (GPU) and signals this to the access manager 220 accordingly.

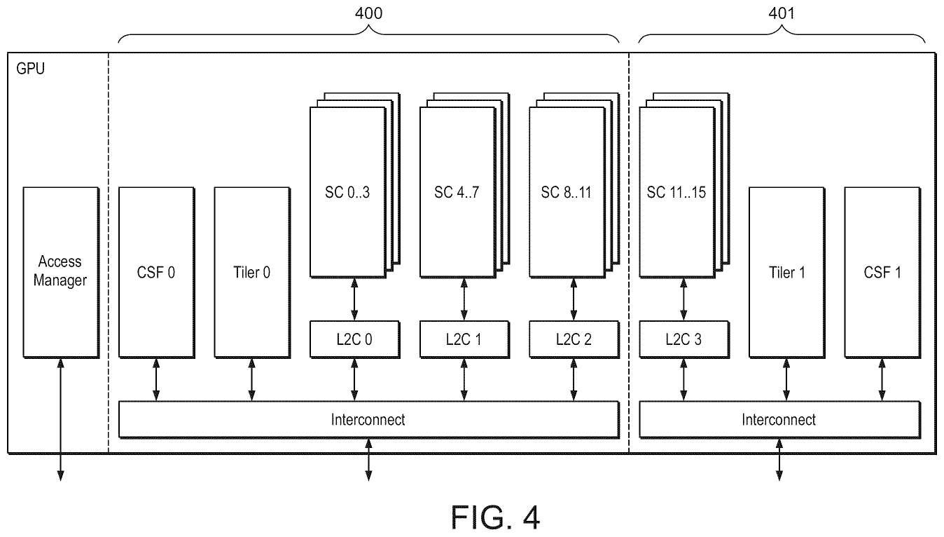

It will be appreciated that FIG. 3 merely shows one example of possible partitioning. For example, FIG. 4 shows another example in which the graphics processor (graphics processing unit) (GPU) is divided into two partitions of different processing capabilities. In particular, in FIG. 4, the first partition has a greater number of shader (processing) cores 200 (in particular, ‘SC 0 . . . 11’) than the second partition, and so the first partition has greater processing capability. This may be appropriate where different processing operations are to be performed wherein one operation requires greater processing effort.

Thus, the technology described herein provides a flexible approach for configuring and re-configuring the processing elements of the graphics processor (graphics processing unit) (GPU) according to the desired processing needs.

In some cases it may be desired to perform processing operations with different levels of functional safety. Again, this is facilitated by the approach according to the present embodiments as different partitions can be effectively isolated in hardware. Thus, it may be the case that one partition of a graphics processor (graphics processing unit) (GPU) is being used to perform safety critical processing, whereas another partition of the graphics processor (graphics processing unit) (GPU) is used to perform non-safety critical processing.

It will be appreciated here that when performing safety critical processing, it will typically be appropriate for the graphics processor (graphics processing unit) (GPU) to support some form of fault detection testing that is operable to detect, and optionally also correct, one or more bit errors in the processing. At least for some types of faults, it may then be appropriate to perform appropriate fault management to mitigate the fault, e.g. by resetting the graphics processor (graphics processing unit) (GPU), or take it offline.

On the other hand, for non-safety critical processing, it may be the case that any errors in the output can be tolerated (e.g. for graphics applications, it is often the case that any output will subsequently be overwritten, so that any errors may not be visible or not perceptively visible).

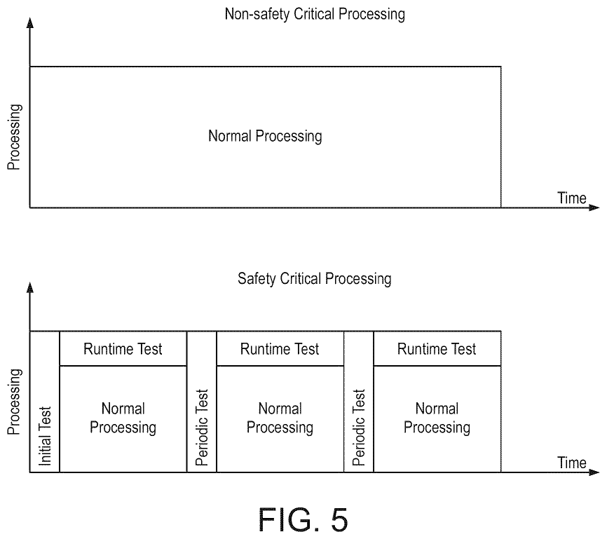

FIG. 5 shows schematically an operation of a processing element in the case when such fault detection testing is or is not enabled. Thus, as shown in FIG. 5, for non-safety critical processing, the processing can be performed as normal, without any specific fault detection testing being enabled. Whereas, for safety critical processing, it may be appropriate to perform fault detection testing, and so this is enabled appropriately.

There are various suitable forms of fault detection testing that may be performed in this regard. For example, as shown in FIG. 5, this could involve periodically interrupting the normal processing to perform periodic fault detection testing (such as using built-in self-testing (BIST) and/or software test library (STL) testing). However, as also shown in FIG. 5, the fault detection testing could also comprise “runtime” testing that is performed alongside, or as part of, the normal operation of the processing element (i.e. without having to interrupt its normal processing).

An example of this might be where ECC memory protection is used to protect memory accesses to one or more internal memory elements within the processing element. Another example might be where processing is implemented in multiplicate, e.g. by performing a double modular redundancy (DMR)/triple modular redundancy (TMR) scheme. In these cases, there is accordingly a significant cost in terms of performance and/or energy consumption for implementing the faulty detection testing.

In the present embodiments, rather than performing any such fault detection testing, and control, for the graphics processor (graphics processing unit) (GPU) as a whole, the fault detection testing (control) can be and is performed in a finer-grained manner, in particular for the respective different partitions of the graphics processor (graphics processing unit) (GPU). Thus, if there is a fault that is only affecting one or more processing elements within one of the partitions (but not the other partition(s), any fault management control operations that may need to be performed, e.g. such as a ‘reset’, can be, and in the present embodiments is, performed in respect of that partition (only), e.g. without necessarily having to reset any other partitions that are not suffering from a fault (or do not need to be managed, e.g. since they are performing non-safety critical processing such that the fault can be safely ignored).

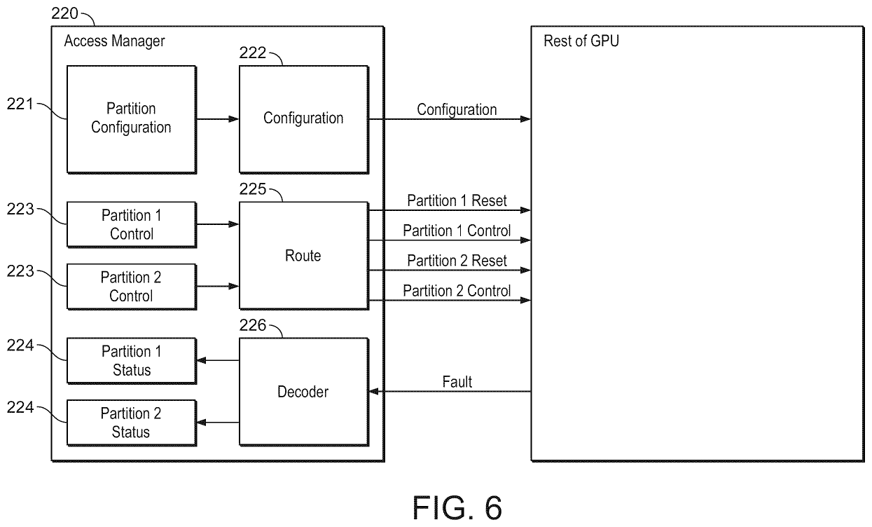

FIG. 6 shows further details of the access manager 220 according to the present embodiments.

As mentioned above, the access manager 220 is operable and configured to control access to the respective processing elements according to the desired partitions. The desired partition configuration 221 is thus determined or stored in the access manager 220 and can be used to set an appropriate configuration state 222 for the rest of the graphics processor (graphics processing unit) (GPU), e.g. by setting appropriate switches, etc., for a configurable interconnect and/or communications network within the graphics processor (graphics processing unit) (GPU) to configure the graphics processor into the respective partitions.

The desired partition configuration 221 may thus be managed in software by an appropriate a higher level (system) controller (not shown) that the access manager 220 is operable to communicate with.

The access manager 220 further includes respective partition control circuits 223 that are operable to issue control signals to the individual processing elements within the different partitions. In this example there are two partition control circuits 223 as the graphics processor (graphics processing unit) (GPU) can be configured as two separate partitions, but other examples would of course be possible. The control signals (e.g. to enable fault detection testing, to perform a reset, etc.) thus pass through an appropriate router 225 to the appropriate partitions of the graphics processor (graphics processing unit) (GPU).

The access manager 220 also comprises respective partition status registers 224 that are operable to monitor the status of the partitions of the graphics processor (graphics processing unit) (GPU) and report potential faults affecting the respective partitions. Again, in this example there are two partition status registers 224 as the graphics processor (graphics processing unit) (GPU) can be configured as two separate partitions, but other examples would of course be possible.

The access manager 220 is thus operable to receive error status signals from the individual processing elements within the graphics processor (graphics processing unit) (GPU), which are passed through a decoder 226 that serves to identify which partition includes the processing element having the potential fault, and then routes that to the appropriate partition status register 224 to update the register accordingly to indicate that there is a fault affecting that partition.

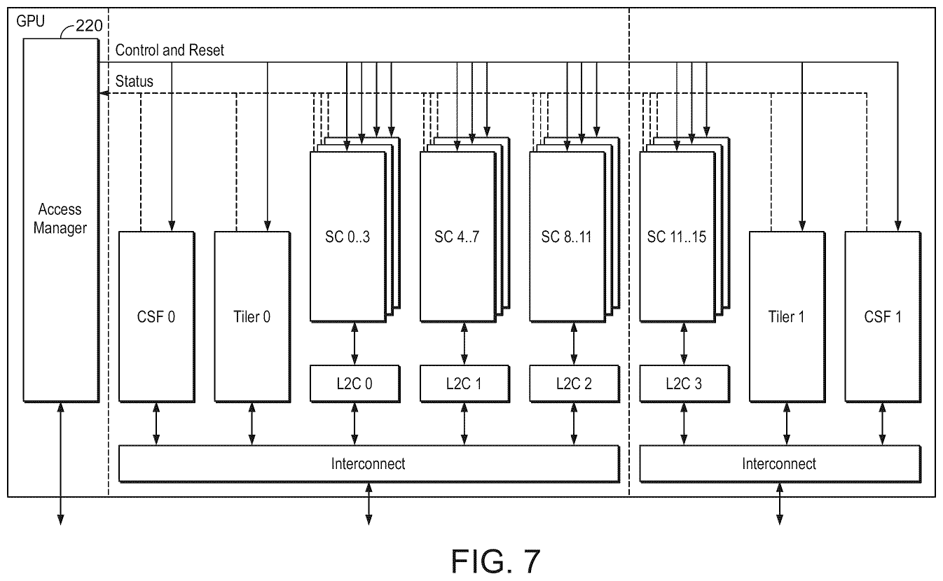

FIG. 7 thus shows further details of the messaging within the graphics processor (graphics processing unit) (GPU). In particular, as shown in FIG. 7, the access manager 220 is operable to issue control (e.g. reset) signals to any of the individual processing elements and also to receive error status signals from any of the individual processing elements. These signals are generated/processed appropriately within the access manager 220 according to the particular configuration of the graphics processor (graphics processing unit) (GPU).

Although not shown in FIG. 7 it will be appreciated that the access manager 220 may generally also be operable to exchange control/status signals with the shared (L2) cache units 216 and indeed any other units that may be present within the graphics processor (graphics processing unit) (GPU) and for which it may be desired for the access manager 220 to communicate with.

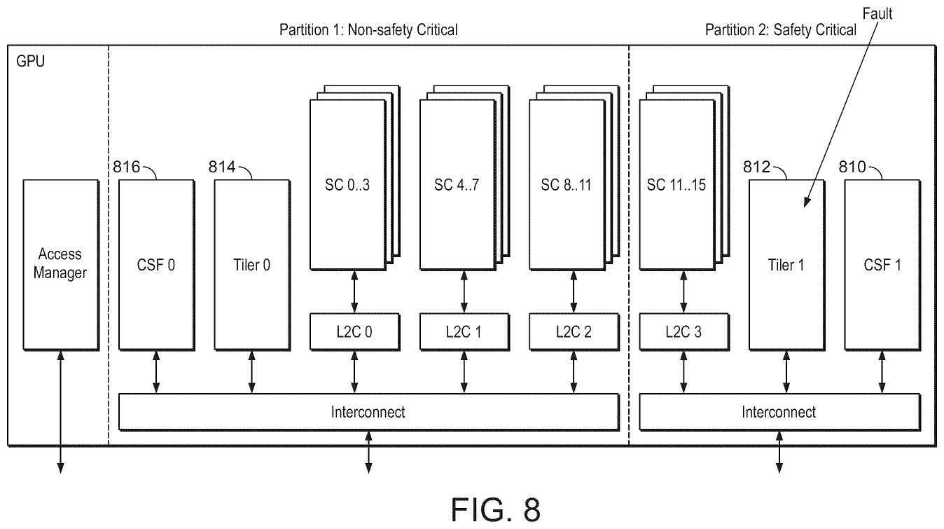

This finer-grained control in combination with the portioning described above also provides further opportunities for improved and finer-grained fault management. To illustrate this, FIG. 8 shows an example of how the graphics processor (graphics processing unit) (GPU) may be re-configured to manage a fault affecting one of the processing elements. In this example, the graphics processor (graphics processing unit) (GPU) is divided into two partitions (as in FIG. 3, above), wherein one of the partitions is performing safety critical processing work and the other partition is performing non-safety critical processing work.

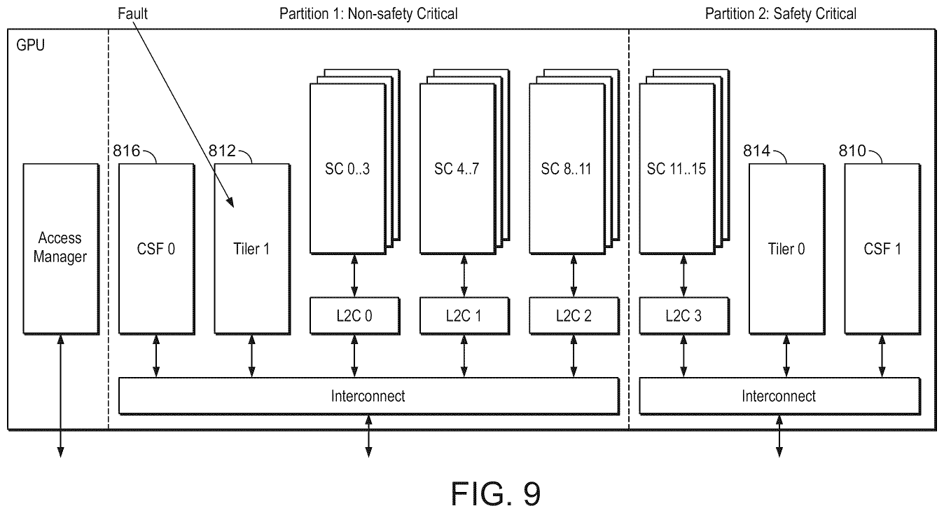

As shown in FIG. 8, a fault is detected within the tiler unit (‘Tiler 1’) of a partition that is performing safety critical processing work. In this case, the fault therefore needs to be appropriately managed. Traditionally, the graphics processor (graphics processing unit) (GPU) may need to be reset, or taken offline, to do this. However, in this example, the other tiler unit (in the other partition that is performing non-safety critical processing work) is still functional. Therefore, as shown in FIG. 9, the still functional tiler unit can be moved to the partition that is performing safety critical processing work. This then addresses the fault in the partition that is performing safety critical processing work, i.e. and thus ensure that the fault does not affect the safety critical processing work.

In this example, as shown in FIG. 9, the faulty tiler unit (‘Tiler 1’) is now included in the partition that is performing the non-safety critical processing work. Thus, the graphics processor (graphics processing unit) (GPU) can be re-configured into different partitions to mitigate the impact of faults.

Various other examples of per-partition fault management may be facilitated by the present embodiments.

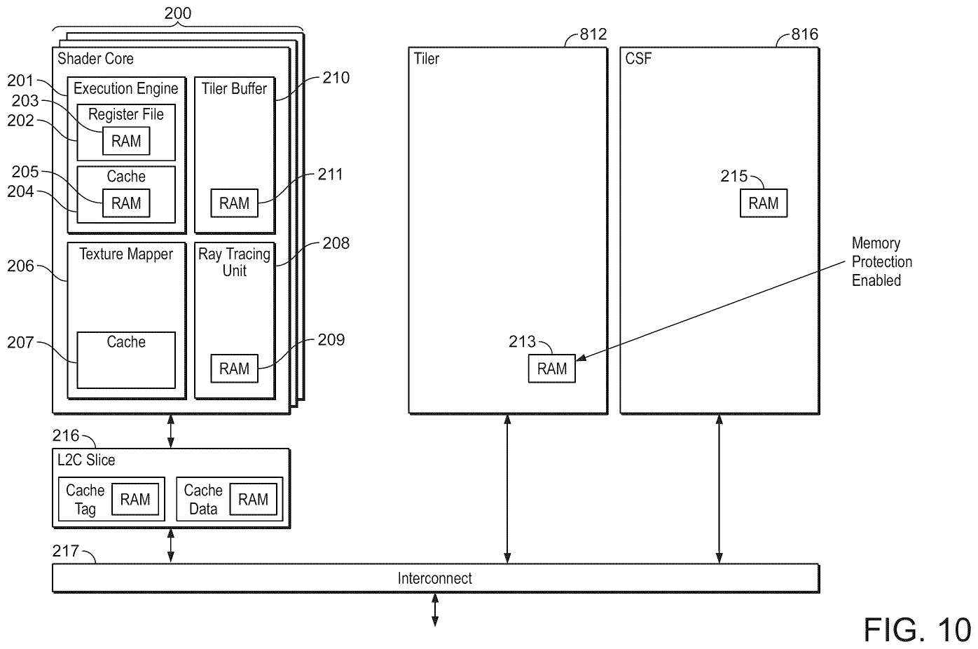

For example, as shown in FIG. 10, and as mentioned above, a graphics processor shader (processing) core comprises a programmable processing unit (circuit) in the form of an execution engine (EE) 201 that perform processing operations by running small programs (often referred to as “shader” programs) for each “item” in an output to be generated such as a render target, e.g. frame. (An “item” in this regard may be, e.g. a vertex, one or more sampling positions, etc..)

The shader core will process each “item” by means of one or more execution threads which will execute the instructions of the shader program(s) in question for the “item” in question. Typically, there will be multiple execution threads each executing at the same time (in parallel).

To facilitate these operations, the execution engine (EE) 201 in FIG. 10 includes a register file 202 including RAM 203 and a cache 204 including RAM 205.

In addition to the programmable execution engine (EE) 201 the graphics processor shader (processing) core in FIG. 10 also includes a number of dedicated (substantially fixed-function) units that can be triggered by the execution engine (EE) 201 to perform certain processing operations as part of shader program execution. For instance, the execution engine (EE) 201 in FIG. 10 includes a dedicated texture mapper (unit) 206 that is operable to perform graphics texturing operations. The texture mapper (unit) 206 includes a texture cache 207. The execution engine (EE) 201 in FIG. 10 also includes a dedicated ray tracing unit 208 including RAM 209 and a tiler buffer 210 including RAM 211 for supporting tile-based processing.

FIG. 10 shows schematically the relevant configuration of one shader (processing) core, but as will be appreciated by those skilled in the art, any further shader (processing) cores of the graphics processor may be configured in a corresponding manner (but may also be configured in a different manner).

As will be appreciated by those skilled in the art there may be other elements of the graphics processor that are not illustrated in FIG. 10. It should also be noted here that FIG. 10 is only schematic, and that, for example, in practice the shown functional units may share significant hardware circuits, even though they are shown schematically as separate units in FIG. 10. It will also be appreciated that each of the elements and units, etc., of the graphics processor as shown in FIG. 10 may, unless otherwise indicated, be implemented as desired and will accordingly comprise, e.g., appropriate circuits (processing logic), etc., for performing the necessary operation and functions.

The graphics processor (graphics processing unit) (GPU) as shown in FIG. 10 thus includes various internal memories (RAMs) that may be used to locally store data for the various functional units of the graphics processor (graphics processing unit) (GPU).

Appropriate memory “error checking” protection may be provided in respect of these RAMs, and in the present embodiments this memory “error checking” protection can in embodiments be selectively enabled (and this can in embodiments be done on a per-RAM basis). For instance, in FIG. 10, memory “error checking” protection is enabled only in respect of the RAM 213 within the tiler unit 812.

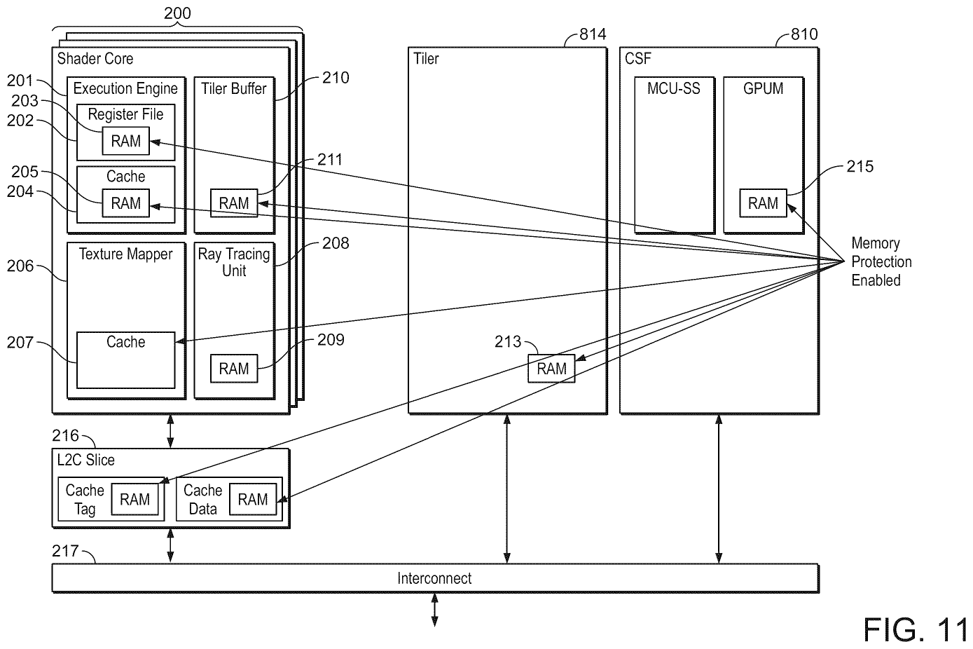

Thus, when a partition is performing safety critical processing work, it may be appropriate to enable this memory “error checking” protection for each of the RAMs within the graphics processor (graphics processing unit) (GPU), and so this is in embodiments done (as shown in FIG. 11). Whereas, when a partition is performing non-safety critical processing work, this may not be necessary. Thus, in general, the memory “error checking” protection may be disabled. In the event of a fault, however, the memory “error checking” protection may then be selectively enabled. For instance, in the example discussed above where there is a fault affecting the tiler unit 812 in the partition that is performing the non-safety critical processing work, it may be appropriate to enable the memory “error checking” protection in respect of the RAM 213 within the tiler unit 812, as this allows the defect to be mitigated (and so this is what is done in FIG. 10).

Various other arrangements would of course be possible in this regard.

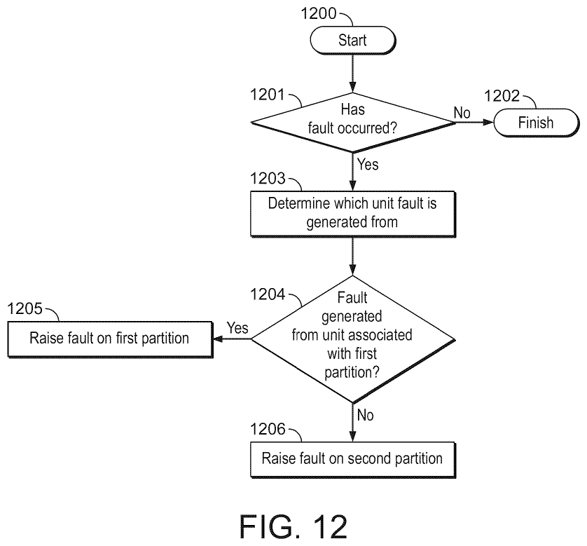

FIG. 12 is a flow chart showing the per-partition control that may be performed by the access circuit 220 according to an embodiment. At the start of the control flow (step 1200), the access circuit 220 may request status updates from processing elements within the graphics processor (graphics processing unit) (GPU) (or these may be periodically provided by the processing elements to the access circuit 220). If no error signal is received indicating that a fault has occurred in any processing element (step 1201—no), the control can finish (step 1202). This operation can then be repeated subsequently (for example, this may be done periodically), to check whether any faults develop.

On the other hand, if an error signal is received from one of the processing elements indicating that a fault has occurred (step 1201—yes), the access circuit 220 then determines which processing unit (or units) is affected the fault (step 1203), and which partition those processing unit(s) are within (step 1204). Thus, if the error signal is generated by a processing unit associated with the first partition (step 1204—yes), a fault is raised on the first partition (step 1205), and appropriate fault management can be performed to mitigate the fault, e.g. as discussed above. Correspondingly, if the error signal is generated by a processing unit associated with the second partition (step 1204—no), a fault is raised on the second partition (step 1206), and appropriate fault management can be performed in respect of the second partition to mitigate the fault.

According to the present embodiments, therefore, the graphics processor (graphics processing unit) (GPU) can be configured and re-configured as different, respective partitions of processing elements, and the fault detection logic (that in embodiments resides within the access circuit 220) is able to identify and manager faults on a partition-by-partition basis. This can then provide finer-grained fault management compared to other possible approaches.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein described herein, in various embodiments and with various modifications as are suited to the particular use contemplated. It is intended that the scope be defined by the claims appended hereto.

1. A data processing system comprising:
a graphics processor that is operable to perform processing work for one or more virtual machines, the graphics processor comprising:
a plurality of processing elements including:
a set of plural processing cores; and
a set of two or more scheduling units, each scheduling unit operable to schedule processing work to processing cores within the set of plural processing cores, each scheduling unit thus operable to provide a respective virtual machine interface for the graphics processor,
wherein the plurality of processing elements within the graphics processor are configurable as different, respective partitions of the processing elements, each partition of processing elements including one or more processing cores from the set of plural processing cores and a respective one of the scheduling units,
wherein at least some of the plurality of processing elements within the graphics processor are operable to undergo fault detecting testing to detect potential faults affecting those particular processing elements, and
wherein the data processing system further comprises:
fault detection circuitry that is operable and configured to identify and/or manage potential faults within particular, respective partitions of the processing elements within the graphics processor.

2. The data processing system of claim 1, wherein the fault detection testing that the processing elements are operable to undergo comprises fault detection testing that, when enabled, is performed alongside or as part of the normal operations performed by the processing elements, and wherein the fault detection circuitry is operable to selectively enable the fault detection testing in respect of individual processing elements within the graphics processor.

3. The data processing system of claim 2, wherein when the plurality of processing elements are configured into different, respective partitions such that there is at least one safety critical partition and at least one non-safety critical partition, the fault detection circuitry is configured to enable the fault detection testing for all processing elements that are able to undergo the fault detection testing within the safety critical partition.

4. The data processing system of claim 2, wherein the fault detection testing comprises a modular redundancy scheme in which at least some processing is performed in multiplicate.

5. The data processing system of claim 2, wherein the fault detection testing comprises an error detection and/or correction memory protection scheme.

6. The data processing system of claim 1, wherein an error status reporting circuit of the fault detection circuitry is operable to receive, from an individual processing element within the graphics processor, a respective error signal indicating that there is a potential fault affecting that processing element, and wherein the error status reporting circuit is further configured to identify which respective partition includes the processing element having the potential fault.

7. The data processing system of claim 1, wherein when the plurality of processing elements are configured into different, respective partitions such that there is at least one safety critical partition and at least one non-safety critical partition, the fault detection circuitry is operable to, in response to identifying that there is a potential fault that is affecting a processing element within a non-safety critical partition, but not affecting any processing elements within any safety critical partition, allow the non-safety critical partition to continue its processing.

8. The data processing system of claim 1, wherein when the plurality of processing elements are configured into different, respective partitions such that there is at least one safety critical partition and at least one non-safety critical partition, the fault detection circuitry is operable to, in response to identifying that there is a potential fault that is affecting a processing element within a safety critical partition, trigger resetting the partition and/or the virtual machine using that partition.

9. The data processing system of claim 8, wherein the data processing system is further operable to, in response to the fault detection circuitry identifying that there is a potential fault that is affecting a processing element within a safety critical partition, trigger re-configuring the graphics processor into different, respective partitions of the processing elements such that the processing element having the fault is moved to a non-safety critical partition.

10. The data processing system of claim 1, wherein the plurality of processing elements further includes a set of plural tiler units, and wherein respective tiler units can be included into respective, different partitions.

11. A method of operating a data processing system that comprises:
a graphics processor that is operable to perform processing work for one or more virtual machines, the graphics processor comprising:
a plurality of processing elements including:
a set of plural processing cores; and
a set of two or more scheduling units, each scheduling unit operable to schedule processing work to processing cores within the set of plural processing cores, each scheduling unit thus operable to provide a respective virtual machine interface for the graphics processor,
wherein the plurality of processing elements within the graphics processor are configurable as different, respective partitions of the processing elements, each partition of processing elements including one or more processing cores from the set of plural processing cores and a respective one of the scheduling units;
the method comprising:
for a particular configuration of the graphics processor into respective first, safety critical partition and a second, non-safety critical partition:
identifying that there is a potential fault affecting one of the processing elements within the graphics processor;
identifying which of the first and second partitions include the processing element having the potential fault; and
determining a respective fault management operation, if any, that is to be performed based on whether the processing element having the potential fault is included in the first or the second partition.

12. The method of claim 11, wherein the fault detection testing that the processing elements are operable to undergo comprises fault detection testing that, when enabled, is performed alongside or as part of the normal operations performed by the processing elements, and wherein the method comprises selectively enabling the fault detection testing in respect of one or more individual processing elements within the graphics processor.

13. The method of claim 12, wherein when the plurality of processing elements are configured into different, respective partitions such that there is at least one safety critical partition and at least one non-safety critical partition, the method comprising enabling the fault detection testing for all processing elements that are able to undergo the fault detection testing within the safety critical partition.

14. The method of claim 12, wherein the fault detection testing comprises a modular redundancy scheme in which at least some processing is performed in multiplicate.

15. The method of claim 12, wherein the fault detection testing comprises an error detection and/or correction memory protection scheme.

16. The method of claim 11, comprising receiving, from an individual processing element within the graphics processor, a respective error signal indicating that there is a potential fault affecting that processing element, and then identifying which respective partition includes the processing element having the potential fault.

17. The method of claim 11, wherein when the plurality of processing elements are configured into different, respective partitions such that there is at least one safety critical partition and at least one non-safety critical partition, the method comprising: in response to identifying that there is a potential fault that is affecting a processing element within a non-safety critical partition, but not affecting any processing elements within any safety critical partition, allowing the non-safety critical partition to continue its processing.

18. The method of claim 11, wherein when the plurality of processing elements are configured into different, respective partitions such that there is at least one safety critical partition and at least one non-safety critical partition, the method comprising: in response to identifying that there is a potential fault that is affecting a processing element within a safety critical partition, resetting the partition and/or the virtual machine using that partition.

19. The method of claim 18, further comprising: determining whether the potential fault affecting the processing element within the safety critical partition is a hard error, and when it is determined that the potential fault affecting the processing element within the safety critical partition is a hard error, re-configuring the graphics processor into different, respective partitions of the processing elements such that the processing element having the hard error is moved to a non-safety critical partition.

20. The method of claim 11, wherein the plurality of processing elements further includes a set of plural tiler units, and wherein respective tiler units can be included into respective, different partitions.
